(19) United States
(12) Patent Application Publication
(10) Pub. No.: US 2001/0008702 A1
(43) Pub. Date: Jul. 19, 2001

(54) Large flexible outdoor/indoor magnetic material decorations

(76) Inventor: Janet Hibbs Vela, Arlington, TX (US)

Correspondence Address: JANET H. VELA, ROBERT A. VELA, 206 CREEK POINT LANE, ARLINGTON, TX, 76002, US

(21) Appl. No.: 09/681,262

(22) Filed: Mar. 9, 2001

(51) Int. Cl. A47G 35/00; G09F 19/00; G09F 17/00

(52) U.S. Cl. 428/542.2; 428/900; 40/594; 40/600; D06/613; 428/7; 428/195

(57) ABSTRACT

Large, unique decorations using flexible magnetic material which would magnetically adhere to any ferrous surface such as patio furniture, doors, garage doors, storage buildings, recreational vehicles, mobile homes, file cabinets, desks and the like. The invention would consist of various methods of applied graphics, such as screen or digital printing, for both seasonal and non-seasonal decorations.

### BACKGROUND OF INVENTION

The present invention relates to improvements to non-skid place mats, any door decorations, and in particular to flexible magnetic material decorations. Heretofore, flexible magnetic material decorations have been small with limited application. It is therefore an object of the present invention to provide larger magnetic decorations for use on outdoor and indoor ferrous surfaces, for example, wrought iron, metal doors, garage doors, and storage buildings.

Heretofore, door decorations required hammer and nail application or over the top of door hooks. It is therefore an object of the present invention to supply an efficient process for easy application and removal of flexible magnetic material decoration without additional means of support and without causing damage to the support surface.

It is already known flexible magnetic material decorations have been patented in application, as cited in U.S. Pat. Nos. D281,230 issued to Olson Sep. 29, 1982; D268,912 issued to Gushea May 10, 1983; D373,115 issued to Logan May 25, 1994; D349,733 issued to Svee Jun. 17, 1991; D386,065 issued to Lewis Jul. 13, 1995; D394,459 issued to Horner Jul. 23, 1997; and U.S. Pat. No. 5,266,920 issued to Langner Apr. 9, 1992. These patents only supply a small, novelty magnet ornamental device for indoor use only.

In accordance with the prior art, as cited in U.S. Pat. No. 4,663,874 issued to Sano; Shigeo; Komatsuzaki; Masato Dec. 21, 1984 and U.S. Pat. No. 5,549,939 issued to Ray Feb. 25, 1994, the use of magnetic material was limited to vehicle use only.

It is already known non-skid place mats have been patented in application, as cited in U.S. Pat. No. 4,457,964 issued to Kaminstein May 28, 1982; U.S. Pat. No. 4,137,356 issued to Shoemaker Oct. 25, 1977; and U.S. Pat. No. 4,326,006 issued to Kaminstein Feb. 5, 1981. All of these patents are limited to the use of materials other than flexible magnetic material.

None of the referenced or other known patents contemplates the use of flexible magnetic material as place mats or large door decorations when applied to any ferrous surface.

The description of the invention, together with the accompanying pictures should not be construed as limiting the invention to the example shown and described, because those skilled in the art to which this appertains will be able to devise other forms thereof within the ambit of the appended claims.

FIG. 1 is a photograph of an example of a rectangular flexible magnetic material place mat, shown on a wrought iron patio table.

FIG. 2 is a photograph of an example of a semi-circular flexible magnetic material place mat, shown on a wrought iron patio table.

FIG. 3 is a photograph of an example of a design for outdoor/indoor decoration consisting of flexible magnetic material and vinyl film, shown on a residential metal door.

FIG. 4 is a photograph of an example of a design for outdoor/indoor decoration consisting of flexible magnetic material and vinyl film, shown on a residential metal door.

### SUMMARY OF INVENTION

The object of the invention is to provide the general public with a unique and timesaving method of large decorations on ferrous surfaces outdoor or indoor.

Sheets of die-cut or manually-cut, flexible magnetic material present an art medium upon which colors may be applied by means of screen printing, digital printing, paint or vinyl film. The invention would adhere to all ferrous surfaces and withstand most climatic conditions. The new uses for prior art would be as follows, but not limited to, decorations on any ferrous surface such as patio furniture, doors, garage doors, storage buildings, and file cabinets.

### BRIEF DESCRIPTION OF DRAWINGS

The foregoing useful features and advantages of the present invention will become more readily appreciated when referenced with the following detailed description of the preferred embodiment of the invention in conjunction with the accompanying photographs, wherein:

FIG. 1 is a photograph of an example of a rectangular flexible magnetic material place mat, shown on a wrought iron patio table.

FIG. 2 is a photograph of an example of a semi-circular flexible magnetic material place mat, shown on a wrought iron patio table.

FIG. 3 is a photograph of an example of a design for outdoor/indoor decoration consisting of flexible magnetic material and vinyl film, shown on a residential metal door.

FIG. 4 is a photograph of an example of a design for outdoor/indoor decoration consisting of flexible magnetic material and vinyl film, shown on a residential metal door.

### DETAILED DESCRIPTION

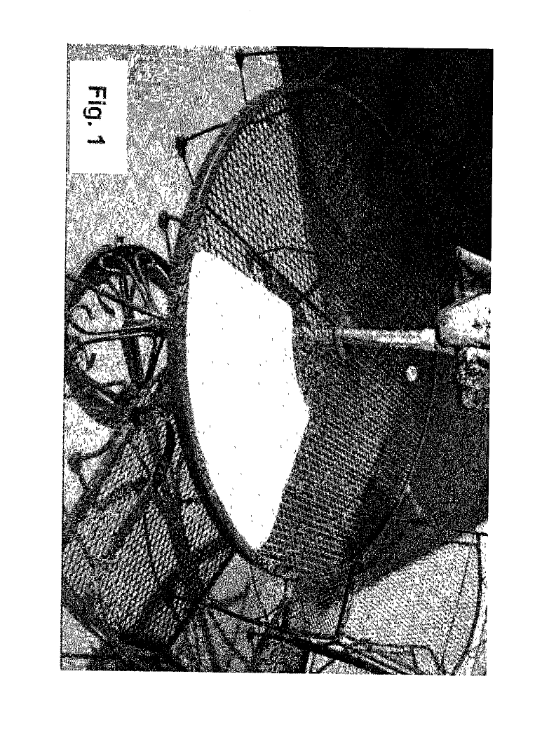

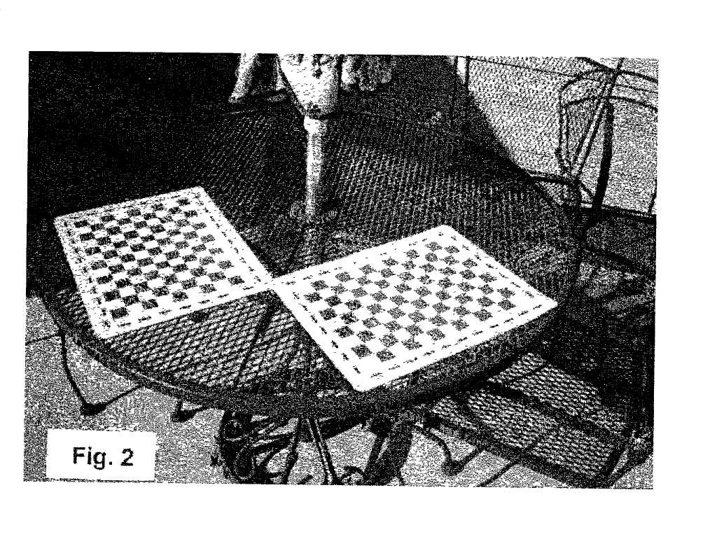

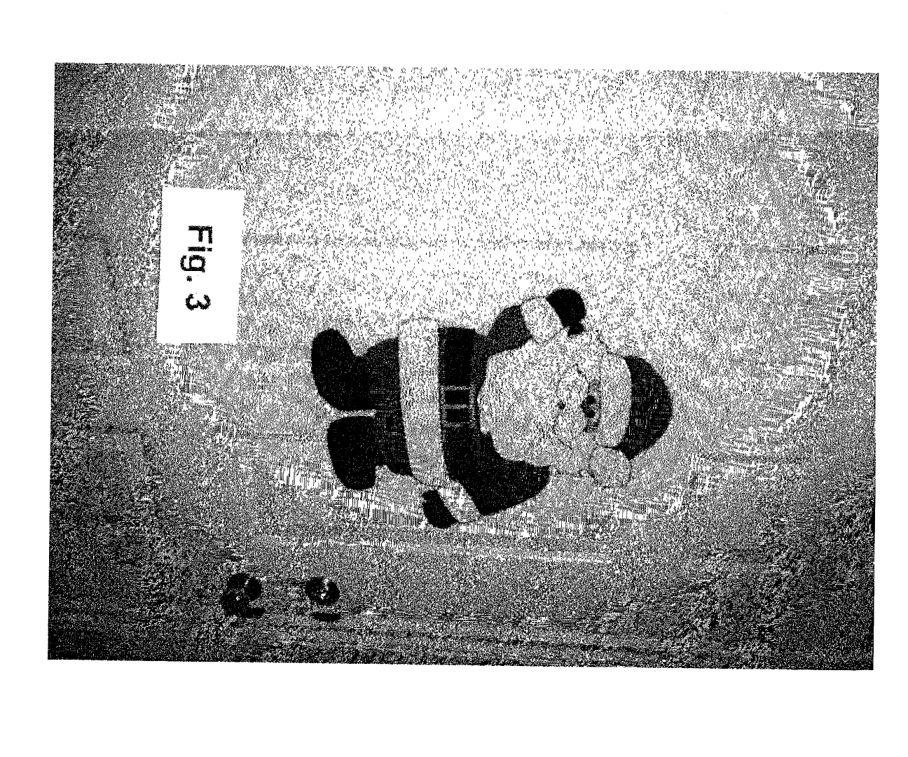

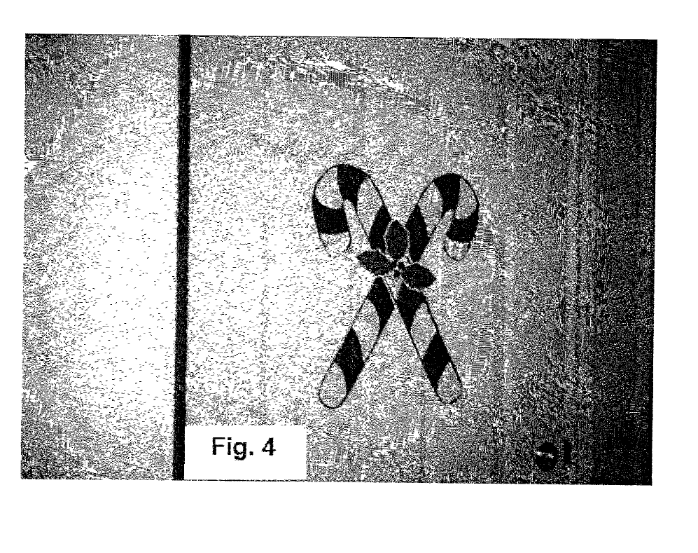

The invention solves a need for decorations that are easily installed and removed, space-saving, timesaving, weatherproof, durable, non-invasive, low maintenance, conveniently stored and functions outdoors and indoors. It may be used in residential or commercial setting on any ferrous surface. The invention process would implement a new use for flexible magnetic material sheeting of any gauge or color held by magnetic attraction against a support surface. The invention art surface material would have colors applied permanently by means of, but not limited to, screen-print, digital print, paint, stencil, ink, or vinyl film. The invention would be either die-cut or manually cut to the shape of the graphics. Referring to FIG. 1 and FIG. 2, the shape would be die-cut for precise sizing. In FIG. 3 and FIG. 4, the shape would be manually cut-to-shape based on desired graphics.

The invention provides a new use of flexible magnetic material for outdoor or indoor decorative processes for seasonal or non-seasonal use. The new application could be implemented as, but not limited to, place mats and decorations for any ferrous surface, such as metal doors, metal garage doors, metal storage buildings, and metal file cabinets.

After exhaustive experiments and research, it was found the invention should be applied to a clean ferrous surface only. For installation the consumer would clean the support surface with soap and water and dry completely using a clean dry cloth and then allow to air dry. The invention is then applied flush with the support surface. It was found in the experiments the invention should not be bent or creased because the invention will crack or split. Though the invention will adhere to a ferrous surface which is not properly cleaned, the magnetic attraction can be limited, creating air pockets under the invention allowing, in some cases, slipping or falling if outdoors during inclement weather. It was also found the invention should be periodically cleaned using water and a mild detergent. However, harsh cleaners and solvents did damage the graphics. Further experiments showed the invention should be stored after removal on a flat cardboard surface with the graphic side up and put in a reusable sealed bag.

The invention solves a need by end users not previously available and a new use for prior art. None of the referenced or other known patents contemplating the use of flexible magnet material addresses the need by the end user for such a product. The modification not previously used is the invention is larger and stands alone as a total decoration. The invention is an alternative to the hammer and nail or adhesive process. There is no need for additional materials to be affixed to the support surface prior to installation. The invention is long lasting and durable with a life expectance of at least 5 years with proper care. End users may change the decorations as frequently as desired without causing damage to the support structure. Unlike prior art, the invention when applied properly will not blow away or stain. Also, it is reusable for many years not just a one-time application.

The invention has been described in detail with particular emphasis on the preferred embodiments thereof, but it should be understood that variations and modifications within the spirit and scope of the invention might occur to those skilled in the art of which the invention pertains.

We claim:

1. A new use for flexible magnetic material comprising a surface larger than, but not limited to, 12 inches by 15 inches; an outdoor/indoor decoration; a die-cut or manually-cut decoration; and a permanently applied graphic to decoration by means of screen-printing, digital printing, paint, ink, or vinyl film.
